(19) United States
(12) Patent Application Publication
(10) Pub. No.: US 2016/0350843 A1
(43) Pub. Date: Dec. 1, 2016

(54) MOBILE DEVICE AUCTION PADDLE

(71) Applicant: eBay Inc., San Jose, CA (US)

(72) Inventors: David Green, San Jose, CA (US); Teil Wise, Campbell, CA (US)

(21) Appl. No.: 14/586,054

(22) Filed: Dec. 30, 2014

Related U.S. Application Data
(60) Provisional application No. 62/059,761, filed on Oct. 3, 2014.

(51) Int. Cl. G06Q 30/08

(52) U.S. Cl. CPC G06Q 30/08; G06F 3/0484

(57) ABSTRACT

Disclosed in some examples is a method for auction bidding using a mobile electronic communication device, the method including receiving an auction initiation user input, the auction initiation user input including a selection of an item in an auction, receiving a bidding initiation user input, the bidding initiation user input corresponding to being ready to submit a first electronic bid for the item, updating the state of the device to an active bidding state in response to receiving the bidding initiation user input, detecting a first device movement; and submitting the first electronic bid in the auction in response to detecting the first device movement while the device is in the active bidding state.

### CLAIM OF PRIORITY

This application claims the benefit of priority under 35 U.S.C. §119(e) of U.S. Provisional Patent Application No. 62/059,761, filed Oct. 3, 2014, the entirety of which is incorporated herein by reference.

### BACKGROUND

Auctions are increasingly involving electronic bidding. Auctions may involve a combination of electronic and traditional, non-electronic bidding. An auctioneer may use various methods to identify or arbitrate between or among multiple bids.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an auction system including both a traditional bidder and mobile bidder according to some examples of the present disclosure.

FIG. 2 shows an example live auction flowchart according to the present disclosure.

FIG. 3 shows a flow diagram of an example bid confirmation method according to some examples of the present disclosure.

FIG. 4 shows an example bid confirmation method and system operating on a device according to some examples of the present disclosure.

FIG. 5 shows an example second device display used to provide additional auction information according to some examples of the present disclosure.

FIG. 6 shows an example bidding device graphical user interface according to some examples of the present disclosure.

FIG. 7 shows a schematic of an example network commerce system according to some examples of the present disclosure.

FIG. 8 shows a schematic of an example mobile device used for participating in an electronic auction according to some examples of the present disclosure.

FIG. 9 shows a schematic of a machine according to some examples of the present disclosure.

### DETAILED DESCRIPTION

Disclosed in some examples are methods, systems, and machine-readable media for using a mobile device as a mobile device auction paddle. Also disclosed in some examples are methods, systems, and machine-readable media for avoiding accidental bidding while using a mobile device as a mobile device auction paddle.

As auctions increasingly involve electronic bidding, auction participants may prefer to participate in an auction using their cell phone, tablet, or other mobile electronic device. For example, a live auction may include bidders who place bids by raising wooden auction paddles. The same live auction may include bidders who place electronic bids by pressing a hardware or software button on their mobile device. The electronic bids may also be placed by using a mobile device as a mobile device auction paddle, where bidders may place bids by raising the device, analogous to placing a bid by raising a wooden auction paddle. The mobile device auction paddle may place a bid electronically upon detecting a motion of the mobile device. One or more safety mechanisms may be applied to reduce the likelihood of accidental bidding, such as using a motion threshold or by requiring a user place a thumb on an input mechanism of the device prior to using the mobile device to place a bid. In auctions involving multiple mobile devices or wooden auction paddles, an auctioneer may interpret the raising of the mobile device auction paddle as an indication of intent to place a bid, and may arbitrate between or among multiple raised paddles to award the current bid.

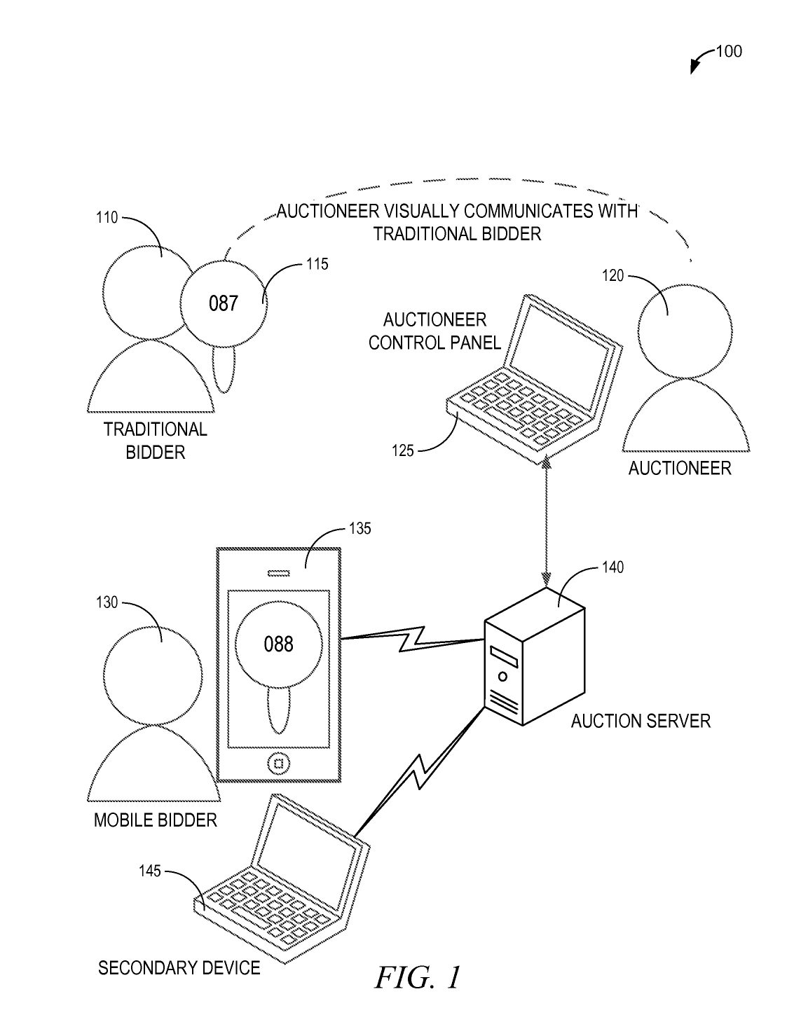

FIG. 1 shows an auction system 100 including both a traditional bidder and mobile bidder according to some examples of the present disclosure. A traditional bidder 110 may raise a wooden paddle 115 to submit a visual bid. The wooden paddle 115 may include a display of a bidder number associated with the traditional bidder 110. An auctioneer 120 may communicate visually with the traditional bidder 110. For example, the auction may include multiple bidders, and the auctioneer may observe that the traditional bidder 110 has raised the wooden paddle 115, and may award the bid to the traditional bidder 110. The auctioneer 120 may use an auctioneer control panel 125 to record a bidder number, record a bidding amount, award an auction item to the traditional bidder 110, or perform other actions.

A mobile bidder 130 may use a mobile device 135 to submit a bid (e.g., submit an electronic bid or indicate an intent to place a visual bid). For example, the mobile bidder 130 may be in the auction room with the auctioneer 120 and the traditional bidder 110. The mobile device 135 may display an image of an auction paddle with a bidder number, and the auctioneer may observe that the mobile bidder 130 has raised the mobile device 135 displaying a paddle, and may award the bid to the mobile bidder 130. The mobile bidder 130 may also submit an electronic bid directly from the mobile device 135. For example, the mobile bidder 130 may be in a remote location, and may press the screen on the mobile device 135 and raise the mobile device 135 to submit a bid. The mobile device 135 may submit the bid to an auction server 140. The auction server 140 may receive one or more bids, and may forward one or more bids to the auctioneer control panel 125. In some examples, the auctioneer control panel may be the same device as the auction server 140.

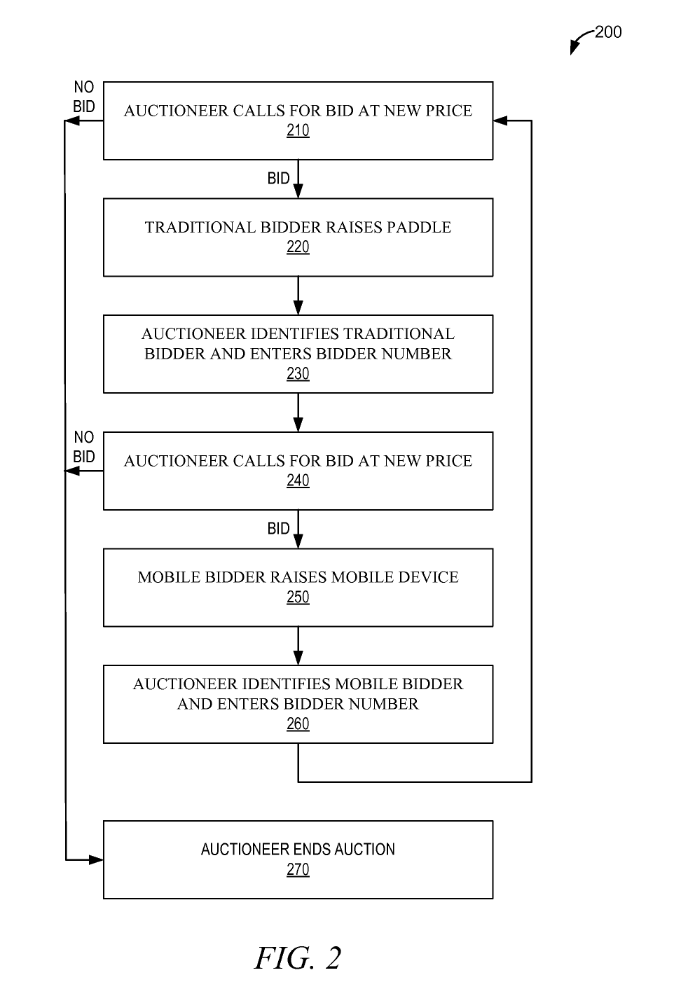

The auctioneer control panel 125 may automatically award bids. For example, for auctions including only electronic bidding, the auctioneer control panel 125 may award a bid to the earliest bidder. The auctioneer 120 may interact with the auctioneer control panel 125 to view or arbitrate between one or more bids. For example, the auctioneer 120 may view a traditional bidder 130 raising a wooden paddle 115 while viewing an electronic bid on the auctioneer control panel 125 submitted by the mobile bidder 130 using the mobile device 135. The auctioneer 120 may arbitrate the bidding based on which bidder submitted the earliest bid, based on which bidder is the higher bidder, or based on other criteria. The auctioneer 120 may indicate the award of the current highest bidder by audibly calling the number on the wooden paddle 115 or on the mobile device 135 auction paddle image, by entering the new highest bidder number in the auctioneer control panel 125, or a combination of both methods. The current highest bidder information may be sent from the auctioneer control panel 125 back to the auction server 140, and bid status information may be sent to the mobile device 135. Bid status information and other information may be communicated between the auction server 140 and a secondary device 145, such as described with respect to FIG. 2.

Turning now to FIG. 2, an example live auction flowchart 200 according to the present disclosure is shown. Flowchart 200 corresponds to an auction that includes one traditional bidder 110, an auctioneer 120, and one mobile bidder 130, such as shown in FIG. 1, though additional bidders may be present in other auctions. In the live auction, the auctioneer may control the bid amount, the traditional bidder may use a wooden paddle, and the mobile bidder may use a mobile device to respond to the auctioneer. The mobile bidder may also use a secondary device to view or hear auction information, or to provide auction input.

The example live auction flowchart 200 begins with the auctioneer calling 210 for a bid at a new price. The new price may be the auction item floor price, or at another price identified by the auctioneer. In the case of the start of the auction, the new price may be the starting bid price. The bid call may be audible within the auction room, where the auctioneer and the traditional bidder may be present within the auction room. The audible bid call may be transduced and transmitted to the mobile bidder, where the audible bid call may be reproduced using a speaker on a mobile device or on a secondary device. The auctioneer may also enter the bid call into an auctioneer control panel, such as a laptop. The bid call information may be transmitted to the mobile bidder, where the bid call information may be displayed on the mobile device or on the secondary device.

In this example live auction flowchart 200, the traditional bidder raises 220 a wooden paddle to indicate an intent to submit a bid at the bid price. The auctioneer views the traditional bidder's wooden paddle, audibly identifies 230 the traditional bidder and bid price, and enters the traditional bidder's identification number in auctioneer control panel. The audible identification may be transmitted to and reproduced on the mobile device or secondary device, or the auctioneer control panel may transmit the bidder identification number and bid price to the mobile device or secondary device. The auctioneer then calls 240 for a bid at a new price. As before, the audible call or electronic call information is transmitted to the mobile bidder and reproduced on the mobile device or on the secondary device. The mobile bidder raises 250 the mobile device to submit a bid. A confirmation of the mobile bid submission may be displayed on the secondary device and at the auctioneer control panel. The mobile device may provide feedback to confirm the mobile bid submission, where the feedback may include a vibration, a change in the display, or an audible sound. The auctioneer audibly identifies 260 the mobile bidder and bid price, and enters the mobile bidder's identification number in auctioneer control panel. This process may be repeated by the auctioneer calling 210 for a new bid price. Alternatively, if a bid is not place by the traditional bidder or by the mobile bidder, the auctioneer may end 270 the auction. The ordering of an auction may be different from the order described, and FIG. 2 is simply one example sequence of events. For example, the mobile bidder may bid first, and the traditional bidder may bid second, or any combination or ordering of mobile bidding and traditional bidding.

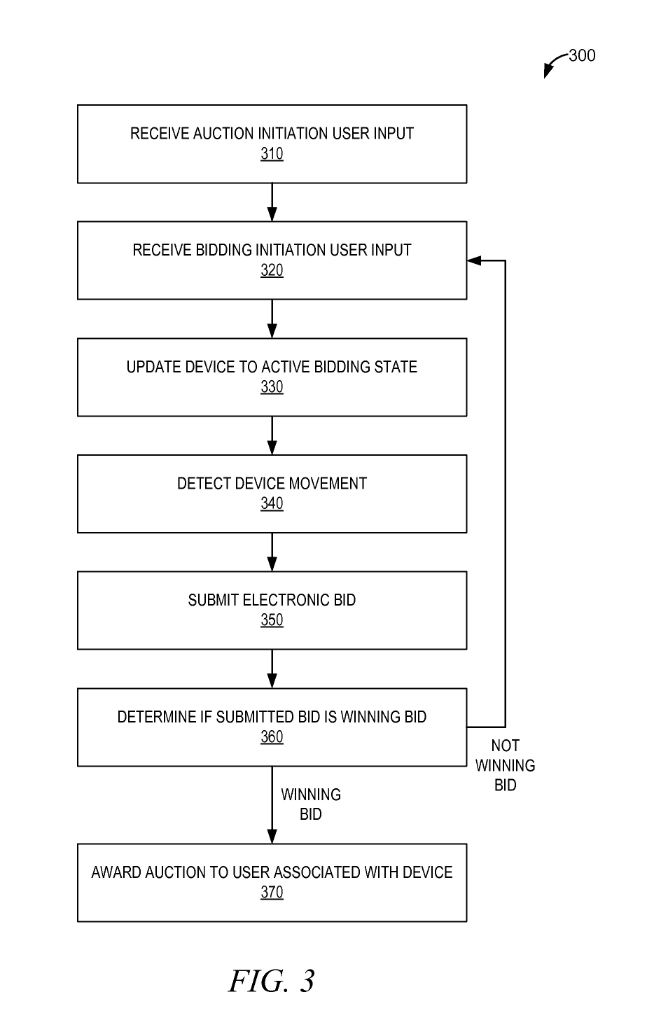

Turning now to FIG. 3, a mobile bid confirmation method 300 according to some examples of the present disclosure is shown. The mobile bid confirmation method 300 may be used within an auction, such as within the live auction flowchart described with respect to FIG. 2. Method 300 is described from the perspective of a mobile bidder, and may be implemented on a mobile electronic communication device, such as a cellular phone, tablet, smartphone, or the like.

The device may receive 310 an auction initiation user input, such as one or more of a selection of an item in an auction, entry of user credentials, selection of an auction, and the like. This auction initiation user input may be sent to an auction server to indicate that this user is participating in the auction. The device may receive 320 a bidding initiation user input. This bidding initiation user input may indicate that the user is ready to submit a first electronic bid for the item. For example, the bidding initiation user input may be a temporary input such as holding down a button, where raising the device while holding the button may submit a bid. The bidding initiation user input may also be a more generalized input, such as entering a bid amount, which may cause a graphical user interface on the device to display a software button on the screen that the user may press to submit a bid.

In response to receiving the bidding initiation user input, the device may update 330 the state of the device to an active bidding state. The active bidding state may indicate that the device is ready to submit a first electronic bid for the item in response to a specific device movement. The specific device movement may include a change in the device location or a change in the device orientation. For example, the specific device movement may include raising the phone, analogous to raising a wooden paddle in an auction. The device may detect 340 the specific device movement. In response to detecting the specific device movement while the device is in the active bidding state, the device may submit 350 the first electronic bid in the auction.

Following submitting 350 the first electronic bid in the auction, the device may display subsequent bidding options, such as entering a new bid value or submitting a new bid. The device may display subsequent bidding options after a predetermined amount of time has elapsed since submitting 350 the first electronic bid in the auction. The device may also display subsequent bidding options in response to detecting a second device movement, such as lowering the device. In response to the second device movement, the device may prepare for an auction response. For example, the device may await a response from the auction server, where the device may use the message to determine 360 if the submitted bid results in being awarded the current highest bid. If the submitted bid was accepted as the current highest bid, the device may provide a display indicating that the auction item has been awarded 370 to the user associated with the device. If the submitted bid was not accepted as the current highest bid, the device may prepare to receive 320 the bidding initiation user input. The device may also prepare for a user input in response to the second device movement. The user input may include displaying a button to submit a subsequent electronic bid for the item.

The user input may include additional bidding options. For example, the device may display a bid value input prompt on the device display, and the user may input a new bid value. The user may also input a new bid value by pressing a hardware or software button, by tilting the device, or by receiving a touchscreen gesture. For example, the bid value input may include a swipe gesture, where the swipe gesture increases a displayed bid by a selected bid increase amount in response to an upward swipe, and where the swipe gesture decreases the displayed bid by a selected bid decrease amount in response to a downward swipe. The selected bid increase and decrease amounts may be an increment determined by the auction, or may be an increment determined by the user. The selected bid increase and decrease amounts may depend on the swipe gesture characteristics. For example, swipe gesture that is fast (e.g., occurs within a selected duration) or long (e.g., occurs across more than half of the screen) may cause a large increase in the bid value.

The device may include a bidder confirmation feedback to facilitate the bidding process for the user or auctioneer. When multiple bidders are participating in an auction, two or more bidders may place a bid at nearly the same time. Depending on whether the bid was placed in person or electronically, various methods may be used by a live auctioneer or an electronic auctioneer (e.g., a computer program) to award (e.g., arbitrate) a current highest bid or an auction-winning bid to a single bidder. For example, an electronic auctioneer may award a bid to the first of two electronic bids, where the first bid is determined as the first bid placed, the first bid received by the electronic auctioneer, or by another means. In another example, a live auctioneer may use their discretion in awarding a bid in an auction involving electronic and live bidders. In response to awarding the bid to a bidder, a bid confirmation for the bid award may be sent to the device. The device may receive the bid confirmation, and a bidder confirmation feedback may provide a confirmation to a bidder that their bid has been accepted. The bidder confirmation feedback may include a visible, audible, or tactile confirmation that the bid has been awarded to the account associated with the device. For example, the device may vibrate, emit a sound, change the display, flash a light, or provide other confirmation. Similarly, an auctioneer feedback mechanism may provide confirmation to the auctioneer that a specific bidder corresponds to the bid that was accepted. In response to receiving the bid confirmation, the device may provide an auctioneer confirmation feedback, such as a visible or audible indication. This auctioneer confirmation feedback may be used instead of or in addition to the bidder confirmation feedback. For example, the device screen facing the auctioneer may temporarily change the display from a bidding paddle to an all-white screen, and the user may detect a vibration in the device during the temporary display change.

The device may include one or more measures to reduce the likelihood of accidental bidding. For example, the user may want to move the phone without accidentally submitting a bid in the auction. The device may include sensors to detect any device movement, such as accelerometers, gyroscopes, or other movement- or location-tracking hardware or software. Detection 340 of the specific device movement may be triggered only when the device movement exceeds a minimum device movement threshold. For example, the device may be configured to require a two-foot vertical displacement of the device. The minimum device movement threshold may be configured within hardware or software, or the threshold may be configured or tested by the user.

The user may also reduce the likelihood of accidental bidding by changing the device bidding state temporarily. The user may change the device state by providing a bidding suspension user input. In response to receiving the bidding suspension user input, the device may update the state of the device to a temporarily suspended bidding state. The bidding initiation user input may include detecting a temporary user input, such as a device screen press or a device button press. Similarly, the bidding suspension user input may include detecting an absence of the temporary user input, such as the release of a device screen press or the release of a device button press. For example, the user may place a thumb on the screen, raise the device to place the bid, lower the device, and remove the thumb from the screen.

The device may reduce the likelihood of accidental bidding by providing a visual feedback for the change in device state. For example, the device may display a first graphical image on a device display in response to receiving the bidding initiation user input. The first graphical image may provide a visual confirmation to the user that the device is currently in an active bidding state. For example, the first graphical image may include an image of a bidding paddle. Additionally, at least a portion of the first graphical image may be used to identify the user uniquely from among multiple bidders in the auction. For example, the first graphical image may include an image of a bidding paddle with a bidder number on the paddle.

The device may change the graphical image to indicate a change in device states. The device may display a second graphical image on the device display in response to receiving the bidding suspension user input. This second graphical image may provide a visual confirmation to the user that the device is in the temporarily suspended bidding state. For example, the user may press a thumb to the screen to switch to the active bidding state and display a bidding paddle, and releasing the thumb from the screen may switch to the temporarily suspended bidding state and display information about the auction item.

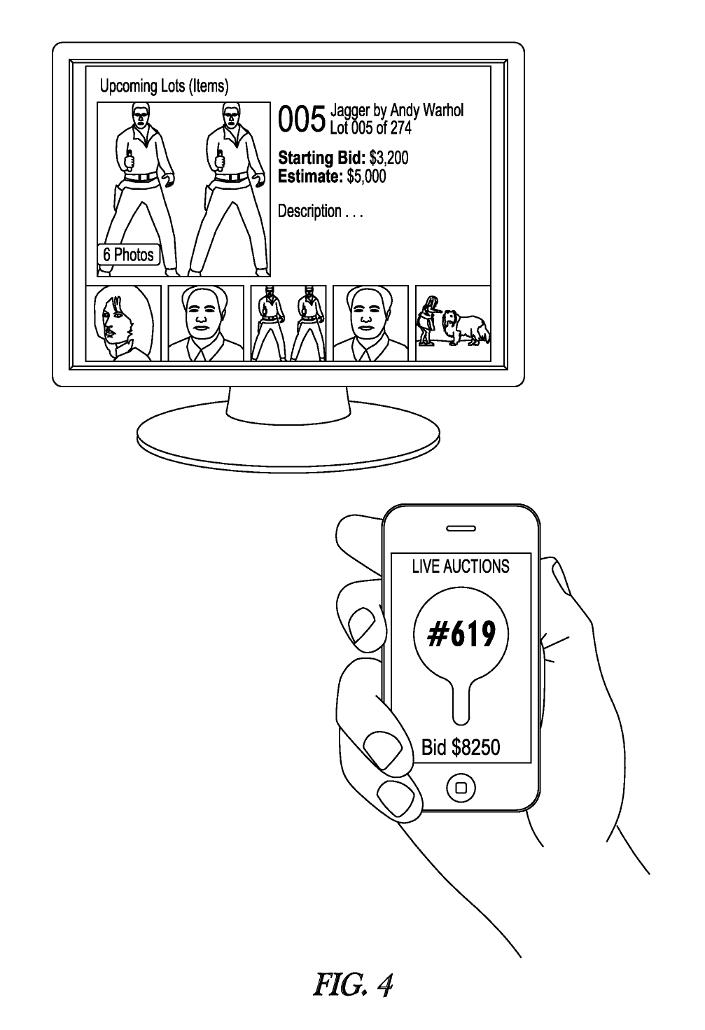

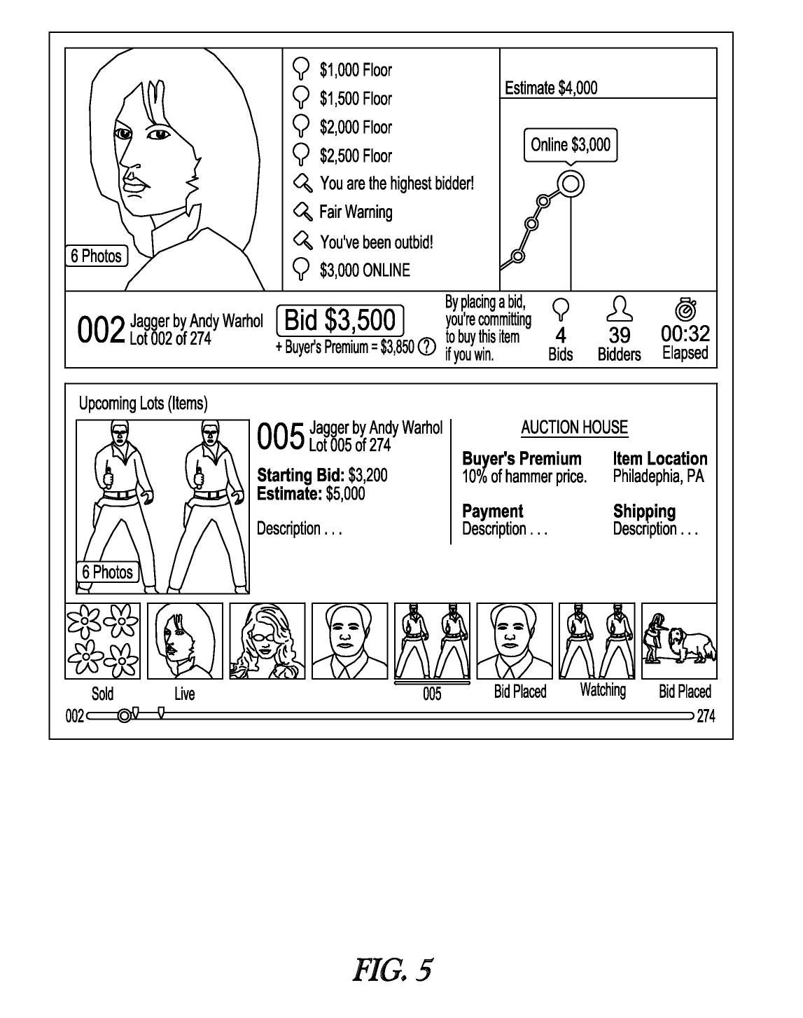

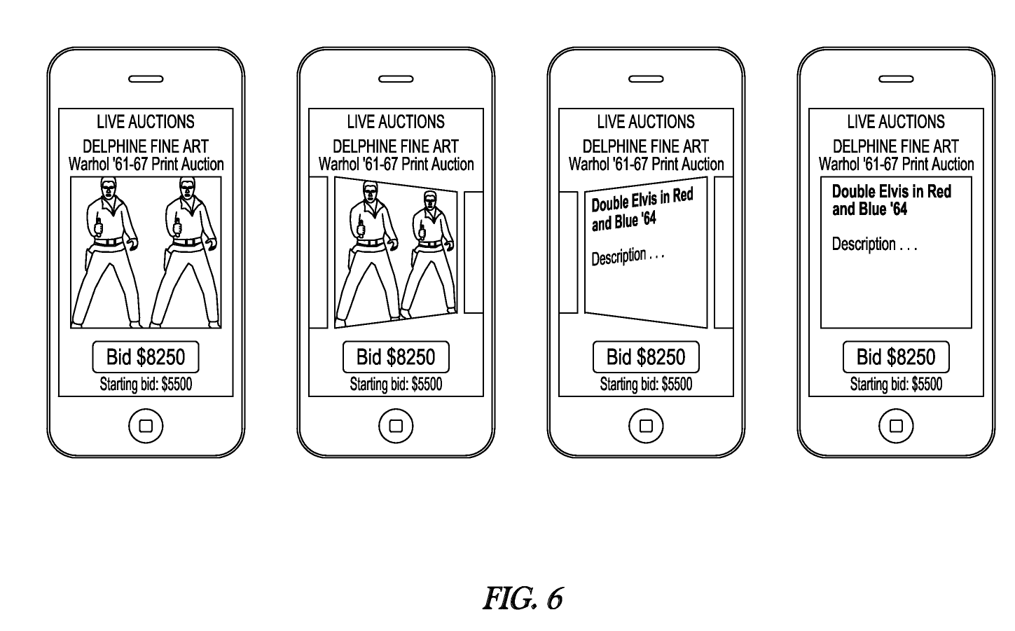

Turning now to FIG. 4, an example bid confirmation method and system 400 operating on a device is shown. The mobile device 410 may display various information about the auction. For example, the display may include the current bid value, the bidder number, and an electronic image of a paddle. The user may place a bid by raising the mobile device. The mobile device may require a user input while the device is raised to place the bid. For example, the mobile device may require the user to hold a device button while raising the device, or the device may require the user to hold a thumb on the touchscreen display while raising the device. A second device 420 may be used to display additional information about one or more auctions, such as shown in FIG. 5. While system 400 includes a mobile device 410 and a second device 420, the auction information and bidding operations within system 400 may all be resident on the mobile device, such as shown in FIG. 6.

Turning now to FIG. 5, a second device display 500 used to provide additional auction information is shown. For example, a second device may display additional static information about the current item, including an item photograph, an indication of the number of available images of the item, the item lot number, or an item title. The second device may display dynamic information about the ongoing auction for the item, including the floor bidding price for the item, a series of status messages for bidding on the item, a software button for placing a bid on the item, an indication of the total cost of the bid and buyer's premium, a graph indicating the relative bidding increases, a reminder of the contractual obligation for winning a bid, the number of item bids, the number of item bidders, or the auction time elapsed. The display may include static information about the next item in the lot, such as an item photograph, an indication of the number of available images of the item, the item lot number, an item title, a starting bid value, a predictive estimate of the winning bid price, or a textual description of the item. The display may include static or dynamic information about other auctions or about the auction provider, such as the total number of items in the auction lot, a photograph of other items in the auction lot, titles of other items, a timeline of the auction items, the title of the auction house, or additional auction information including the buyer's premium, the item location, payment, or shipping information. The second device display may be provided using a desktop computer, a tablet, a cellular phone, an internet-connected smart TV, or another device.

Turning now to FIG. 6, a bidding device graphical user interface 600 is shown. As described above, the mobile device may be used to place electronic bids, and a secondary device may be used to display information about the auction. The graphical user interface 600 may enable the mobile device to operate without the use of a secondary device, thus providing a standalone auction bidding experience. The mobile device may be configured to switch between a standalone mode and an electronic bidding mode. For example, a user may place a bid using the mobile device in an electronic paddle mode, switch to a standalone mode to view information about other items within the auction lot, then switch back to the electronic paddle mode to place another bid.

As shown in FIG. 6, the bidding device graphical user interface 600 may include additional information about the item, and may provide a graphical user interface to receive a user bidding input. For example, the device graphical user interface may include the title 610 of the auction item, a photograph of the auction item 620, a software bidding button 630, and a starting bid amount 640. The user may place a bid by pressing and releasing the software bidding button 630, or may place a bid by pressing a device hardware button 650 or the screen and raising the device.

The device graphical user interface may allow the user to access additional information about the device. For example, tapping on the photograph of the auction item may cause the display to appear to flip the photograph 620 of the auction item, and additional item information 660 may be displayed on the reverse side of the electronic photograph 620. Various gestures may be used to distinguish between placing a bid and requesting additional information. For example, a single tap may flip the photograph, whereas pressing and holding the screen while raising the device may place a bid for the item. The informational elements or user inputs in the graphical user display may be generated according to a predetermined template, or may be generated dynamically according to available information. For example, a predetermined template may be used to generate a graphical user interface that includes either a photograph of the auction item or a text description in the place of the photograph. In another example, when an image of the bidding item is unavailable, the graphical user interface may dynamically resize the software bidding button, or the graphical user interface may generate a software button that triggers an internet search for the auction item title.

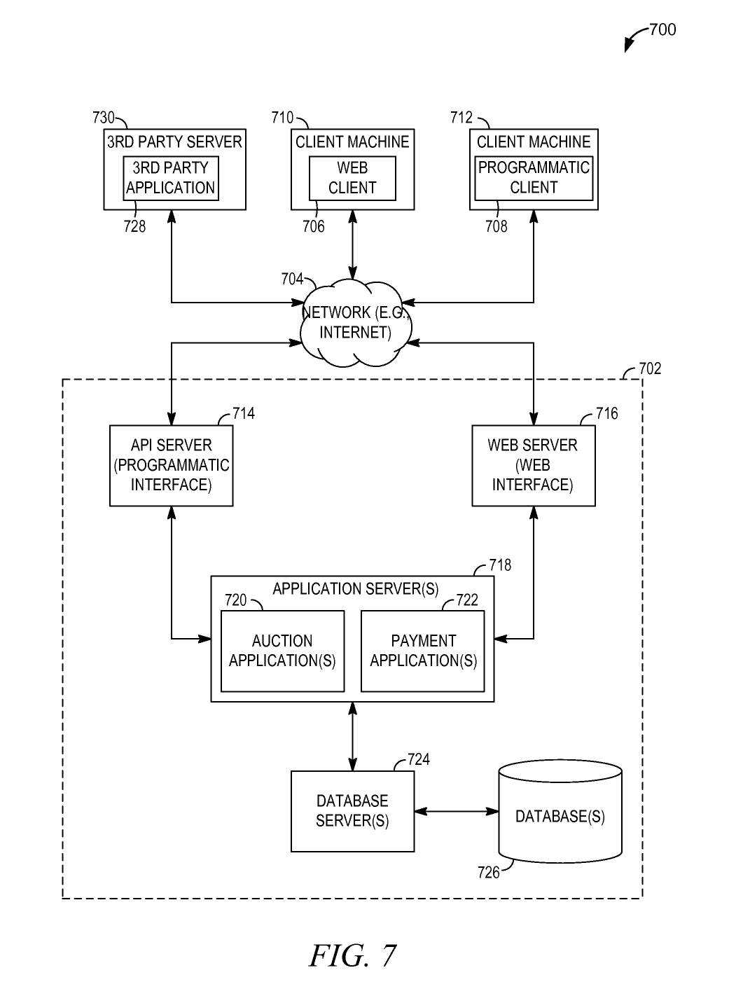

FIG. 7 is a network diagram depicting a client-server auction system 700 on which the mobile device auction paddle may be deployed. A networked system 702, in the example forms of a network-based auction or publication system, provides server-side functionality, via a network 704 (e.g., the Internet or Wide Area Network (WAN)) to one or more clients. For example, the mobile device auction paddle may be deployed on a web client 706 (e.g., a browser, such as the Internet Explorer browser developed by Microsoft Corporation of Redmond, Wash. State) on client machine 710, such as may be displayed on a cell phone web browser, desktop web browser, or other client web browser. In another example, the mobile device auction paddle may be deployed on a programmatic client 708 executing on a machine 712, such as a mobile device application on a mobile device, a program on a desktop computer, or other programmatic client. An Application Program Interface (API) server 714 and a web server 716 are coupled to, and provide programmatic and web interfaces respectively to, one or more application servers 718. The application servers 718 host one or more auction applications 720 and payment applications 722. The application servers 718 are, in turn, shown to be coupled to one or more databases servers 724 that facilitate access to one or more databases 726.

The auction applications 720 may provide a number of auction functions and services to users that access the networked system 702. The payment applications 722 may likewise provide a number of payment services and functions to users. The payment applications 722 may allow users to accumulate value (e.g., in a commercial currency, such as the U.S. dollar, or a proprietary currency, such as “points”) in accounts, and then later to redeem the accumulated value for products (e.g., goods or services) that are made available via the auction applications 720. While the auction and payment applications 720 and 722 are shown in FIG. 7 to both form part of the networked system 702, it will be appreciated that, in alternative embodiments, the payment applications 722 may form part of a payment service that is separate and distinct from the networked system 702. One or more of auction and payment applications 720 and 722, web client 706, programmatic client 708, or other components may store user account information about users of those components. Example information may include payment information, shipping information, user preferences, or the like. Additionally, one or more of auction and payment applications 720 and 722, web client 706, programmatic client 708, or other components may include the action confirmation mechanisms disclosed herein.

Further, while the system 700 shown in FIG. 7 employs client-server architecture, the present invention is of course not limited to such an architecture, and could equally well find application in a distributed, or peer-to-peer, architecture system, for example. The various auction and payment applications 720 and 722 could also be implemented as standalone software programs, which do not necessarily have networking capabilities.

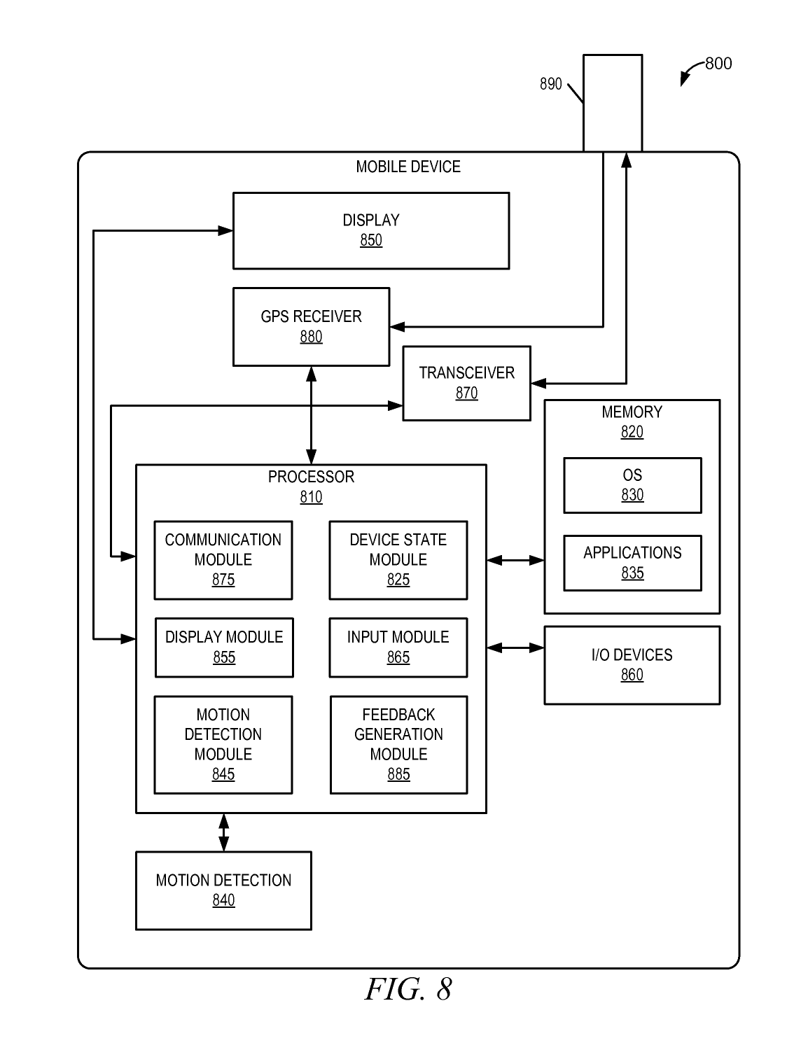

The web client 706 accesses the various auction and payment applications 720 and 722 via the web interface supported by the web server 716. Similarly, the programmatic client 708 accesses the various services and functions provided by the auction and payment applications 720 and 722 via the programmatic interface provided by the API server 714. The programmatic client 708 may, for example, be a seller application (e.g., the TurboLister application developed by eBay Inc., of San Jose, Calif.) to enable sellers to author and manage listings on the networked system 702 in an off-line manner, and to perform batch-mode communications between the programmatic client 708 and the networked system 702. In other examples, the programmatic client may include a mobile application executing on a mobile device (such as the mobile device described with respect to FIG. 8) which may allow the user of the mobile application to bid on, purchase, view, and/or list items for sale on the online auction. The programmatic client 708 may include the action confirmation features discussed herein. The confirmation features discussed herein may also be part of the web-based interface provided by web server 716 and displayed by web client 706 of the client machine 710.

A third party application 728 may execute on a third party server machine 730. The third party application 728 may have programmatic access to the networked system 702 via the programmatic interface provided by the API server 714. For example, the third party application 728 may, using information retrieved from the networked system 702, support one or more features or functions on a website hosted by the third party. The third party website may, for example, provide one or more promotional, auction or payment functions that are supported by the relevant applications of the networked system 702.

FIG. 8 is a block diagram illustrating a mobile device 800 used for participating in an electronic auction, according to an example embodiment upon which various embodiments may execute. The mobile device 800 may be a device specifically provided by the auctioneer for use within an auction, or may be a multi-purpose mobile device owned by a user, such as a smartphone. The mobile device 800 may include a processor 810 for executing various electronic auction methods. The processor 810 may be any of a variety of different types of commercially available processors suitable for mobile devices (for example, an XScale architecture microprocessor, a Microprocessor without Interlocked Pipeline Stages (MIPS) architecture processor, a processor operating according to a Reduced Instruction Set (RISC) such as a PowerPC processor, a processor operating according to a Complex Instruction Set (CISC) such as an Intel x086 processor, or another type of processor).

A memory 820, such as a Random Access Memory (RAM), a Flash memory, or other type of memory, may be communicatively coupled to the processor (e.g., through a bus or other communication pipeline). The memory 820 may be adapted to store an operating system (OS) 830, as well as application programs 835, such as an application which allows users to create final product images according to the present disclosure. Example operating systems include the Android OS developed by Google Inc., of Mountain View Calif., iOS developed by Apple of Cupertino, Calif., Windows Mobile developed by Microsoft Corp., of Redmond Wash., or the like. The processor 810 may include a device state module 825 configured to interact with memory 820 to retrieve, update, and store the state of the mobile device 800 to an active bidding state or to an inactive bidding state.

The processor 810 may be coupled, either directly or via appropriate intermediary hardware, to a display 850 and to one or more input/output (I/O) devices 860, such as a keypad, a touch panel sensor, a microphone, and the like. For example, the mobile device 800 may include multi-touch-screen displays which support input entry through multi-touch gestures. The single-touch or multi-touch gestures may be used to enter various auction input, to indicate the user is prepared to place a bid, or to submit an electronic bid. Example multi-touch screen displays include capacitive touch screen displays, resistive touch screen displays, or the like. The processor 810 may include an input module 865, where the input module 865 may be configured to interpret or perform actions in response to actions received by I/O device 860.

The processor 810 may include a display module 855, where the display module 855 may be configured to generate various display outputs to be displayed on display 850. The processor 810 may include a feedback generation module 885, where the feedback generation module 885 may be configured to provide a bidder confirmation feedback or to provide an auctioneer confirmation feedback in response to receiving a bid confirmation, such as to display 850.

The processor 810 may be coupled, either directly or via appropriate intermediary hardware, to one or more motion detection devices 840, such as an accelerometer, a gyroscope, and the like. The motion detection device 840 may be used to place a bid, or may be used with an I/O device 860 to place a bid. For example, the user may place a thumb on a touchscreen, raise the device to place a bid, lower the device, and remove the thumb from the screen. The processor 810 may include a motion detection module 845, where the motion detection module 845 may be configured to receive information from the motion-sensing component 840.

Similarly, in some embodiments, the processor 810 may be coupled to a transceiver 870 that interfaces with an antenna 890. The processor 810 may include a communication module 875, where the communication module 875 may be configured to interpret or perform actions in response to actions received by transceiver 870. The transceiver 870 may be configured to both transmit and receive cellular network signals, wireless data signals, or other types of signals via the antenna 890, depending on the nature of the mobile device 800. In this manner, a connection with a communication network may be established. For example, the transceiver may operate in accordance with a 2^{nd} Generation wireless network (e.g., a Global System for Mobile Communications GSM network, a General Packet Radio Service GPRS network), a 3^{rd} Generation wireless network (e.g., a Universal Mobile Telecommunications Network UMTS), a 4^{th} Generation wireless network (e.g., Long Term Evolution LTE, Long Term Evolution-Advanced LTE-A), a network according to an Institute for Electrical and Electronics Engineers IEEE 802.11 family of standards (such as 802.11n) or the like. Further, in some configurations, a Global Positioning System receiver 880 may also make use of the antenna 890 to receive GPS signals. Mobile device 800 may access networked system 702 of FIG. 7 through the execution of a programmatic client 708 or a web client 706, or some other client.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then later access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or in a “software as a service” (SaaS) type architecture. For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site. A computer program can be distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

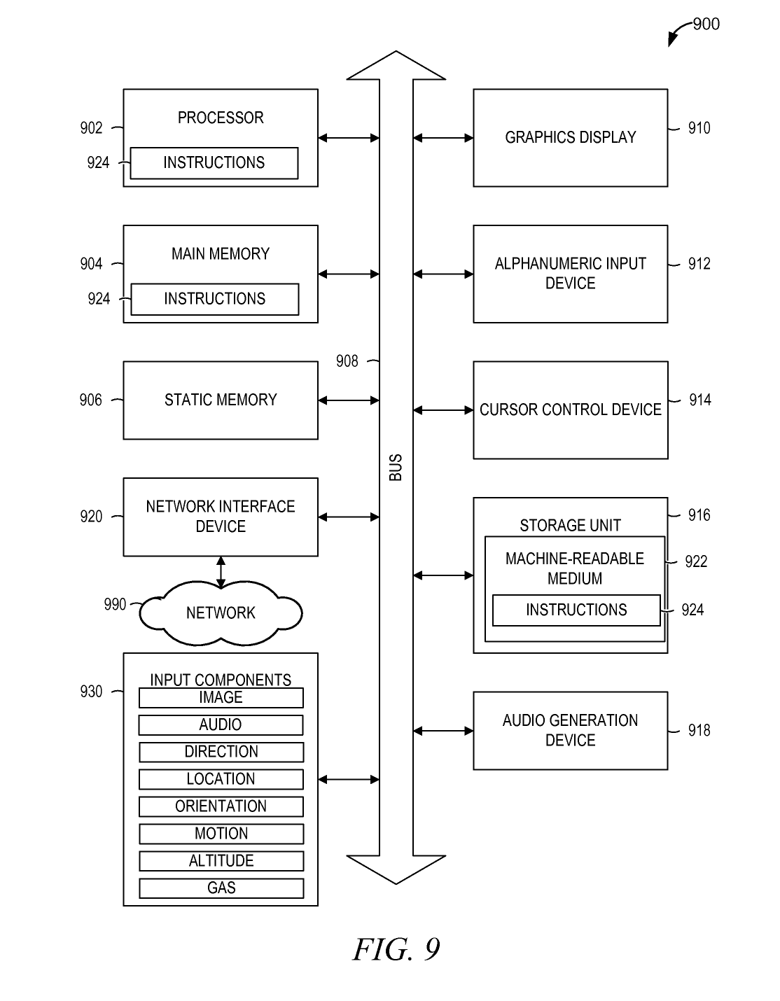

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein can be executed, in whole or in part.

In alternative embodiments, the machine 900 operates as a standalone device or can be connected (e.g., networked) to other machines. In a networked deployment, the machine 900 can operate in the capacity of a server machine or a client machine in a server-client network environment, or as a peer machine in a distributed (e.g., peer-to-peer) network environment. The machine 900 can be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine 900 capable of executing the instructions 924, sequentially or otherwise, that specify actions to be taken by that machine 900. Further, while only a single machine 900 is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 can contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 can be configurable to execute one or more modules (e.g., software modules) described herein.

The machine 900 can further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 can also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 can also reside, completely or at least partially, within the main memory 904, within the processor 902 (e.g., within the processor's cache memory), or both, before or during execution thereof by the machine 900. Accordingly, the main memory 904 and the processor 902 can be considered machine-readable media 922 (e.g., tangible and non-transitory machine-readable media). The instructions 924 can be transmitted or received over the network 990 via the network interface device 920. For example, the network interface device 920 can communicate the instructions 924 using any one or more transfer protocols (e.g., hypertext transfer protocol (HTTP)).

In some example embodiments, the machine 900 can be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 930 can be accessible and available for use by any of the modules described herein.

As used herein, the term “memory” refers to a machine-readable medium 922 able to store data temporarily or permanently and can be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database 330, or associated caches and servers) able to store instructions 924. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Certain embodiments are described herein as including logic or a number of components, modules, or mechanisms. Modules can constitute software modules (e.g., code stored or otherwise embodied on a machine-readable medium 922 or in a transmission medium), hardware modules, or any suitable combination thereof. A “hardware module” is a tangible (e.g., non-transitory) unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor 902 or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a field programmable gate array (FPGA) or an ASIC. A hardware module can also include programmable logic or circuitry that is temporarily configured by software to perform certain operations. For example, a hardware module can include software encompassed within a general-purpose processor 902 or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, and such a tangible entity can be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 902 configured by software to become a special-purpose processor, the general-purpose processor 902 can be configured as respectively different special-purpose processors (e.g., comprising different hardware modules) at different times. Software (e.g., a software module) can accordingly configure one or more processors 902, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can later access the memory device to retrieve and process the stored output. Hardware modules can also initiate communications with input or output devices, and can operate on a resource (e.g., a collection of information).

The various operations of example methods described herein can be performed, at least partially, by one or more processors 902 that are temporarily configured (e.g., by software) or permanently configured to perform the relevant operations. Whether temporarily or permanently configured, such processors 902 can constitute processor-implemented modules that operate to perform one or more operations or functions described herein. As used herein, “processor-implemented module” refers to a hardware module implemented using one or more processors 902.

Similarly, the methods described herein can be at least partially processor-implemented, a processor 902 being an example of hardware. For example, at least some of the operations of a method can be performed by one or more processors 902 or processor-implemented modules. As used herein, “processor-implemented module” refers to a hardware module in which the hardware includes one or more processors 902. Moreover, the one or more processors 902 can also operate to support performance of the relevant operations in a “cloud computing” environment or as a “software as a service” (SaaS). For example, at least some of the operations can be performed by a group of computers (as examples of machines 900 including processors 902), with these operations being accessible via a network 990 (e.g., the Internet) and via one or more appropriate interfaces (e.g., an application program interface (API)).

The performance of certain operations can be distributed among the one or more processors 902, not only residing within a single machine 900, but deployed across a number of machines 900. In some example embodiments, the one or more processors 902 or processor-implemented modules can be located in a single geographic location (e.g., within a home environment, an office environment, or a server farm). In other example embodiments, the one or more processors 902 or processor-implemented modules can be distributed across a number of geographic locations.

### Other Notes

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to limit the scope of this application voluntarily to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### Other Examples

Example 1 includes a mobile electronic communication device comprising a display, an input device, a motion-sensing component, and a processor, wherein the processor is configured to include an input module configured to: receive an auction initiation user input, the auction initiation user input including a selection of an item in an auction, receive a bidding initiation user input, the bidding initiation user input corresponding to being ready to submit an acceptance of a bid price for the item, a device state module configured to update the state of the device to an active bidding state in response to receiving the bidding initiation user input, a motion detection module configured to receive information from the motion-sensing component and to detect a first device movement, and a communication module configured to receive a bid price corresponding to the item in the auction, submit the acceptance of the bid price in response to detecting the first device movement while the device is in the active bidding state.

Example 2 includes the device of example 1, wherein the motion detection module detecting a first device movement includes detecting a bidding motion of the device, the bidding motion corresponding to raising a bidding paddle in the auction.

Example 3 includes the device of example 1, wherein the motion detection module detecting a first device movement includes detecting a change in a device location.

Example 4 includes the device of example 1, wherein the motion detection module detecting a first device movement includes detecting a change in a device orientation.

Example 5 includes the device of example 1, wherein the motion detection module detecting a first device movement includes determining the first device movement has exceeded a minimum movement threshold.

Example 6 includes the device of example 1, wherein the input module is further configured to receiving a bidding suspension user input, and the device state module is further configured to update the state of the device to a temporarily suspended bidding state in response to receiving the bidding suspension user input.

Example 7 includes the device of any of examples 1-6, wherein the input module receiving the bidding initiation user input includes detecting a presence of a temporary user input, and the input module receiving the bidding suspension user input includes detecting an absence of the temporary user input.

Example 8 includes the device of any of examples 1-7, wherein the temporary user input includes a device screen press or a device button press.

Example 9 includes the device of example 1, wherein the processor is further configured to include a display module, the display module to cause the display to include a first graphical image in response to receiving the bidding initiation user input, the first graphical image providing a visual confirmation that the device is in the active bidding state, wherein at least a portion of the first graphical image is unique among a plurality of bidders in the auction.

Example 10 includes the device of any of examples 1-9, wherein the first graphical image includes a bidding paddle.

Example 11 includes the device of any of examples 1-6, wherein the processor display module is further configured to cause the display to include a second graphical image on the device display in response to receiving the bidding suspension user input, the second graphical image providing a visual confirmation that the device is in the temporarily suspended bidding state.

Example 12 includes the device of example 1, wherein the processor motion detection module is further configured to detect a second device movement, and the processor device state module is further configured to change the state of the device to a secondary bidding state in response to the second device movement, the secondary bidding state corresponding to being ready to submit an acceptance of a subsequent bid price for the item.

Example 13 includes the device of example 1, wherein the processor display module is further configured to display a bid value input prompt on the device display, and the processor input module is further configured to receive a bid value input.

Example 14 includes the device of any of examples 1-13, wherein the bid value input include a swipe gesture, the swipe gesture increases a displayed bid by a selected bid increase amount in response to an upward swipe, and the swipe gesture decreases the displayed bid by a selected bid decrease amount in response to a downward swipe.

Example 15 includes the device of example 1, wherein the processor communication module is further configured to receive a bid confirmation at the device, the bid confirmation corresponding to an auction acceptance of the first electronic bid.

Example 16 includes the device of any of examples 1-15, the mobile electronic communication device further including a feedback component, the processor further configured to include a feedback generation module to provide an auctioneer confirmation feedback in response to receiving the bid confirmation, the auctioneer confirmation feedback including a visible or audible indication to allow the auctioneer to confirm that the device placed the first electronic bid.

Example 17 includes the device of any of examples 1-15, wherein the processor feedback generation module is further configured to provide a bidder confirmation feedback in response to receiving the bid confirmation, the bidder confirmation feedback including a visible, audible, or tactile indication to allow a user of the device to confirm that the device placed the first electronic bid.

Example 18 includes a non-transitory machine-readable medium including instructions that, when executed by a machine, cause the machine to perform operations comprising receiving an auction initiation user input, the auction initiation user input including a selection of an item in an auction, receiving a bid price corresponding to the item in the auction, receiving a bidding initiation user input, the bidding initiation user input corresponding to being ready to submit an acceptance of the bid price, updating the state of the device to an active bidding state in response to receiving the bidding initiation user input, detecting a first device movement, and submitting an acceptance of the bid price in the auction in response to detecting the first device movement while the device is in the active bidding state.

Example 19 includes the non-transitory machine-readable medium of example 18, wherein detecting the first device movement includes detecting a bidding motion of the device, the bidding motion corresponding to raising a bidding paddle in the auction.

Example 20 includes the non-transitory machine-readable medium of example 18, wherein the first device movement includes a change in a device location.

Example 21 includes the non-transitory machine-readable medium of example 18, wherein the first device movement includes a change in a device orientation.

Example 22 includes the non-transitory machine-readable medium of example 18, wherein detecting the first device movement includes determining the first device movement has exceeded a minimum movement threshold.

Example 23 includes the non-transitory machine-readable medium of example 18, the operations further including receiving a bidding suspension user input, and updating the state of the device to a temporarily suspended bidding state in response to receiving the bidding suspension user input.

Example 24 includes the non-transitory machine-readable medium of any of examples 1-23, wherein receiving the bidding initiation user input includes detecting a presence of a temporary user input, and receiving the bidding suspension user input includes detecting an absence of the temporary user input.

Example 25 includes the non-transitory machine-readable medium of any of examples 1-24, wherein the temporary user input includes a device screen press or a device button press.

Example 26 includes the non-transitory machine-readable medium of example 18, the operations further including displaying a first graphical image on a device display in response to receiving the bidding initiation user input, the first graphical image providing a visual confirmation that the device is in the active bidding state, wherein at least a portion of the first graphical image is unique among a plurality of bidders in the auction.

Example 27 includes the non-transitory machine-readable medium of any of examples 1-26, wherein the first graphical image includes a bidding paddle.

Example 28 includes the non-transitory machine-readable medium of any of examples 1-23, the operations further including displaying a second graphical image on the device display in response to receiving the bidding suspension user input, the second graphical image providing a visual confirmation that the device is in the temporarily suspended bidding state.

Example 29 includes the non-transitory machine-readable medium of example 18, the operations further including detecting a second device movement, and changing the state of the device to a secondary bidding state in response to the second device movement, the secondary bidding state corresponding to being ready to submit an acceptance of a subsequent bid price for the item.

Example 30 includes the non-transitory machine-readable medium of example 18, the operations further including displaying a bid value input prompt on the device display, and receiving a bid value input.

Example 31 includes the non-transitory machine-readable medium of any of examples 1-30, wherein the bid value input include a swipe gesture, the swipe gesture increases a displayed bid by a selected bid increase amount in response to an upward swipe, and the swipe gesture decreases the displayed bid by a selected bid decrease amount in response to a downward swipe.

Example 32 includes the non-transitory machine-readable medium of example 18, the operations further including receiving a bid confirmation at the device, the bid confirmation corresponding to an auction acceptance of the first electronic bid.

Example 33 includes the non-transitory machine-readable medium of any of examples 1-32, the operations further including providing an auctioneer confirmation feedback in response to receiving the bid confirmation, the auctioneer confirmation feedback including a visible or audible indication to allow the auctioneer to confirm that the device placed the first electronic bid.

Example 34 includes the non-transitory machine-readable medium of any of examples 1-32, the operations further including providing a bidder confirmation feedback in response to receiving the bid confirmation, the bidder confirmation feedback including a visible, audible, or tactile indication to allow a user of the device to confirm that the device placed the first electronic bid.

Example 35 includes a method for auction bidding using a mobile electronic communication device, the method comprising receiving an auction initiation user input, the auction initiation user input including a selection of an item in an auction, receiving a bid price corresponding to the item in the auction, receiving a bidding initiation user input, the bidding initiation user input corresponding to being ready to submit an acceptance of the bid price, updating the state of the device to an active bidding state in response to receiving the bidding initiation user input, detecting a first device movement, and submitting the acceptance of the bid price in response to detecting the first device movement while the device is in the active bidding state.

Example 36 includes the method of example 35, wherein detecting the first device movement includes detecting a bidding motion of the device, the bidding motion corresponding to raising a bidding paddle in the auction.

Example 37 includes the method of example 35, wherein the first device movement includes a change in a device location.

Example 38 includes the method of example 35, wherein the first device movement includes a change in a device orientation.

Example 39 includes the method of example 35, wherein detecting the first device movement includes determining the first device movement has exceeded a minimum movement threshold.

Example 40 includes the method of example 35, further including receiving a bidding suspension user input, and updating the state of the device to a temporarily suspended bidding state in response to receiving the bidding suspension user input.

Example 41 includes the method of any of examples 1-40, wherein receiving the bidding initiation user input includes detecting a presence of a temporary user input, and receiving the bidding suspension user input includes detecting an absence of the temporary user input.

Example 42 includes the method of any of examples 1-41, wherein the temporary user input includes a device screen press or a device button press.

Example 43 includes the method of example 35, further including displaying a first graphical image on a device display in response to receiving the bidding initiation user input, the first graphical image providing a visual confirmation that the device is in the active bidding state, wherein at least a portion of the first graphical image is unique among a plurality of bidders in the auction.

Example 44 includes the method of any of examples 1-43, wherein the first graphical image includes a bidding paddle.

Example 45 includes the method of any of examples 1-40, further including displaying a second graphical image on the device display in response to receiving the bidding suspension user input, the second graphical image providing a visual confirmation that the device is in the temporarily suspended bidding state.

Example 46 includes the method of example 35, further including detecting a second device movement, and changing the state of the device to a secondary bidding state in response to the second device movement, the secondary bidding state corresponding to being ready to submit an acceptance of a subsequent bid price for the item.

Example 47 includes the method of example 35, further including displaying a bid value input prompt on the device display, and receiving a bid value input.

Example 48 includes the method of any of examples 1-47, wherein the bid value input include a swipe gesture, the swipe gesture increases a displayed bid by a selected bid increase amount in response to an upward swipe, and the swipe gesture decreases the displayed bid by a selected bid decrease amount in response to a downward swipe.

Example 49 includes the method of example 35, further including receiving a bid confirmation at the device, the bid confirmation corresponding to an auction acceptance of the first electronic bid.

Example 50 includes the method of any of examples 1-49, further including providing an auctioneer confirmation feedback in response to receiving the bid confirmation, the auctioneer confirmation feedback including a visible or audible indication to allow the auctioneer to confirm that the device placed the first electronic bid.

Example 51 includes the method of any of examples 1-49, further including providing a bidder confirmation feedback in response to receiving the bid confirmation, the bidder confirmation feedback including a visible, audible, or tactile indication to allow a user of the device to confirm that the device placed the first electronic bid.

What is claimed is:

1. A mobile electronic communication device comprising:
a display;
an input device;
a motion-sensing component; and
a processor;
wherein the processor is configured to include:
an input module configured to receive a bidding initiation user input, the bidding initiation user input corresponding to being ready to submit an acceptance of a bid price for the item;
a device state module configured to update the state of the device to an active bidding state in response to receiving the bidding initiation user input;
a motion detection module configured to receive information from the motion-sensing component and to detect a first device movement; and
a communication module configured to submit the acceptance of the bid price in response to detecting the first device movement while the device is in the active bidding state.

2. The device of claim 1, wherein the motion detection module detecting a first device movement includes:
detecting a bidding motion of the device, the bidding motion corresponding to raising a bidding paddle in the auction; and
detecting a first device movement includes determining the first device movement has exceeded a minimum movement threshold.

3. The device of claim 1, wherein:
the input module receiving the bidding initiation user input includes detecting a presence of a temporary user input the temporary user input including a device screen press or a device button press;
the input module is further configured to receive a bidding suspension user input, the bidding suspension user input including detecting an absence of the temporary user input; and
the device state module is further configured to update the state of the device to a temporarily suspended bidding state in response to receiving the bidding suspension user input.

4. The device of claim 3, wherein the processor is further configured to include a display module, the display module is configured to:
cause the display to include a first graphical image in response to receiving the bidding initiation user input, the first graphical image providing a visual confirmation that the device is in the active bidding state, wherein at least a portion of the first graphical image is unique among a plurality of bidders in the auction and at least a portion of the first graphical image includes a bidding paddle; and
cause the display to include a second graphical image on the device display in response to receiving the bidding suspension user input, the second graphical image providing a visual confirmation that the device is in the temporarily suspended bidding state.

5. The device of claim 1, wherein:
the communication module is further configured to receive a bid price corresponding to the item in the auction;
the display module is further configured to display a bid value input prompt on the device display; and
the input module is further configured to receive a bid value input, the bid value input including a swipe gesture, wherein:
the swipe gesture increases a displayed bid by a selected bid increase amount in response to an upward swipe; and
the swipe gesture decreases the displayed bid by a selected bid decrease amount in response to a downward swipe.

6. The device of claim 1, wherein:
the processor communication module is further configured to receive a bid confirmation at the device, the bid confirmation corresponding to an auction acceptance of the first electronic bid; and
the mobile electronic communication device further includes a feedback component, the processor further configured to include a feedback generation module configured to provide a bidder confirmation feedback in response to receiving the bid confirmation, the bidder confirmation feedback including a visible, audible, or tactile indication to allow a user of the device to confirm that the device placed the first electronic bid.

7. The device of claim 6, wherein the processor feedback generation module is further configured to provide an auctioneer confirmation feedback in response to receiving the bid confirmation, the auctioneer confirmation feedback including a visible or audible indication to allow the auctioneer to confirm that the device placed the first electronic bid.

8. A non-transitory machine-readable medium including instructions that, when executed by a machine, cause the machine to perform operations comprising:
receiving, from an input device at an input module, a bidding initiation user input, the bidding initiation user input corresponding to being ready to submit an acceptance of a bid price for the item;
updating, via a device state module, the state of the device to an active bidding state in response to receiving the bidding initiation user input;
receiving, from a motion-sensing component at a motion detection module, information from the motion-sensing component and to detect a first device movement; and
submitting, via a communication module, the acceptance of the bid price in response to detecting the first device movement while the device is in the active bidding state.

9. The non-transitory machine-readable medium of claim 8, wherein detecting a first device movement includes:
detecting a bidding motion of the device, the bidding motion corresponding to raising a bidding paddle in the auction; and
detecting a first device movement includes determining the first device movement has exceeded a minimum movement threshold.

10. The non-transitory machine-readable medium of claim 8, wherein receiving the bidding initiation user input includes detecting a presence of a temporary user input the temporary user input including a device screen press or a device button press, and wherein the instructions cause the machine to perform further operations comprising:
receiving, at the input module, a bidding suspension user input, the bidding suspension user input including detecting an absence of the temporary user input; and
updating, at the device state module, the state of the device to a temporarily suspended bidding state in response to receiving the bidding suspension user input.

11. The non-transitory machine-readable medium of claim 10, wherein the instructions cause the machine to perform further operations comprising:
displaying, in response to receiving the bidding initiation user input, a first graphical image on a device display via a display module, the first graphical image providing a visual confirmation that the device is in the active bidding state, wherein at least a portion of the first graphical image is unique among a plurality of bidders in the auction and at least a portion of the first graphical image includes a bidding paddle; and
displaying, in response to receiving the bidding suspension user input, a second graphical image on the device display via the display module, the second graphical image providing a visual confirmation that the device is in the temporarily suspended bidding state.

12. The non-transitory machine-readable medium of claim 8, wherein the instructions cause the machine to perform further operations comprising:
receiving, at the communication module, a bid price corresponding to the item in the auction;
displaying, on the device display via the display module, a bid value input prompt; and
receiving, at the input module, a bid value input, the bid value input including a swipe gesture, wherein:
the swipe gesture increases a displayed bid by a selected bid increase amount in response to an upward swipe; and
the swipe gesture decreases the displayed bid by a selected bid decrease amount in response to a downward swipe.

13. The non-transitory machine-readable medium of claim 8, wherein the instructions cause the machine to perform further operations comprising:
receiving, at the processor communication module, a bid confirmation at the device, the bid confirmation corresponding to an auction acceptance of the first electronic bid;
providing, in response to receiving the bid confirmation, a bidder confirmation feedback from a feedback generation module via a feedback component, the bidder confirmation feedback including a visible, audible, or tactile indication to allow a user of the device to confirm that the device placed the first electronic bid; and
providing, in response to receiving the bid confirmation, an auctioneer confirmation feedback from the feedback generation module via the feedback component, the auctioneer confirmation feedback including a visible or audible indication to allow the auctioneer to confirm that the device placed the first electronic bid.

14. A method for auction bidding using a mobile electronic communication device, the method comprising:
receiving, from an input device at an input module, a bidding initiation user input, the bidding initiation user input corresponding to being ready to submit an acceptance of a bid price for the item;
updating, via a device state module, the state of the device to an active bidding state in response to receiving the bidding initiation user input;
receiving, from a motion-sensing component at a motion detection module, information from the motion-sensing component and to detect a first device movement; and
submitting, via a communication module, the acceptance of the bid price in response to detecting the first device movement while the device is in the active bidding state.

15. The method of claim 14, further comprising:
detecting a bidding motion of the device, the bidding motion corresponding to raising a bidding paddle in the auction; and
detecting a first device movement includes determining the first device movement has exceeded a minimum movement threshold.

16. The method of claim 14, wherein receiving the bidding initiation user input includes detecting a presence of a temporary user input the temporary user input including a device screen press or a device button press, and wherein the method further includes:
receiving, at the input module, a bidding suspension user input, the bidding suspension user input including detecting an absence of the temporary user input; and
updating, at the device state module, the state of the device to a temporarily suspended bidding state in response to receiving the bidding suspension user input.

17. The method of claim 16, further comprising:
displaying, in response to receiving the bidding initiation user input, a first graphical image on a device display via a display module, the first graphical image providing a visual confirmation that the device is in the active bidding state, wherein at least a portion of the first graphical image is unique among a plurality of bidders in the auction and at least a portion of the first graphical image includes a bidding paddle; and
displaying, in response to receiving the bidding suspension user input, a second graphical image on the device display via the display module, the second graphical image providing a visual confirmation that the device is in the temporarily suspended bidding state.

18. The method of claim 14, further comprising:
receiving, at the communication module, a bid price corresponding to the item in the auction;
displaying, on the device display via the display module, a bid value input prompt; and
receiving, at the input module, a bid value input, the bid value input including a swipe gesture, wherein:
the swipe gesture increases a displayed bid by a selected bid increase amount in response to an upward swipe; and
the swipe gesture decreases the displayed bid by a selected bid decrease amount in response to a downward swipe.

19. The method of claim 14, further comprising:
receiving, at the processor communication module, a bid confirmation at the device, the bid confirmation corresponding to an auction acceptance of the first electronic bid;
providing, in response to receiving the bid confirmation, a bidder confirmation feedback from a feedback generation module via a feedback component, the bidder confirmation feedback including a visible, audible, or tactile indication to allow a user of the device to confirm that the device placed the first electronic bid; and

20. The method of claim 19, further comprising providing, in response to receiving the bid confirmation, an auctioneer confirmation feedback from the feedback generation module via the feedback component, the auctioneer confirmation feedback including a visible or audible indication to allow the auctioneer to confirm that the device placed the first electronic bid.
